(19) United States
(12) Patent Application Publication
(10) Pub. No.: US 2012/0254009 A1
(43) Pub. Date: Oct. 4, 2012

(54) Real-time commodity exchange system and method

(76) Inventor: Jonathan Scott Thorp, Fairburn, SD (US)

(21) Appl. No.: 13/314,282

(22) Filed: Dec. 8, 2011

Related U.S. Application Data
(60) Provisional application No. 61/471,350, filed on Apr. 4, 2011.

(51) Int. Cl. G06Q 40/04

(52) U.S. Cl. 705/37

(57) ABSTRACT

The present invention generally relates to commodity exchange systems. Specifically, this invention relates to a system and method for providing real-time commodity exchanges for point of sale transactions.

### CROSS REFERENCE TO RELATED APPLICATIONS

This application claims the benefit of U.S. Provisional Patent Application No. 61/471,350 Filed Apr. 4, 2011, the entire disclosure of which is incorporated herein by reference.

### FIELD OF THE INVENTION

The present invention generally relates to commodity exchange systems. Specifically, this invention relates to a system and method for providing real-time commodity exchanges for point of sale transactions.

### BACKGROUND OF THE INVENTION

As markets and trading systems advance, so do the needs for allowing real-time or near real-time liquidity from equity and commodity markets. Presently, if a consumer in possession of commodities wishes to exchange those commodities for cash or other liquid asset, the consumer must first execute a sale or option on those commodities, wait for settlement of the transaction and for the delivery of the liquid asset. This process can take days or even weeks, depending on the amount, type and other characteristics associated with the commodity.

Unfortunately, often consumers have a need for the liquid asset much sooner than can be provided for through market and trading systems currently in the prior art. Even where the consumer may not have an immediate need for the liquid asset, there is always a desire to be more mobile and reactive with one's assets. Having to wait days or weeks can cause issues with investment strategies and execution of said strategies. This is especially the case where the consumer may not have the credit to trade on a settlement price prior to the settlement occurring.

Additionally, since consumers must keep some amount of their assets in a constant liquid form to cover daily necessities (e.g., bills, consumables, entertainment), the consumer loses the ability to have these assets utilized in commodity markets.

Therefore, there is a need in the art for a system and method for providing consumers or other entities the ability to conduct real-time point of sale transactions based on commodities. These and other features and advantages of the present invention will be explained and will become obvious to one skilled in the art through the summary of the invention, drawings, brief description of the drawings and detailed description that follows.

### SUMMARY OF THE INVENTION

Accordingly, the present invention provides a system and method for providing users with the ability to conduct real-time commodity exchanges for use with the completion of point of sale transactions. In this manner, users enjoy the liquidity of cash currencies while retaining the stability and value retention of commodities. In a preferred embodiment, the point of sale merchant may be made oblivious to the fact that the system and method are being utilized for the completion of the point of sale transaction.

According to embodiments of the present invention, the system may be configured to provide a link between a commodities account and a payment source. In an exemplary embodiment, the payment source may be one of a standard type utilized in regular commerce (e.g., credit card, debit card, check).

According to embodiments of the present invention, the system may be configured to receive a point of sale transaction request from a merchant in response to the user utilizing a commodity account linked payment source.

According to embodiments of the present invention, the system may be configured to check the status of a commodities account in response to a request to commit a particular transaction.

According to embodiments of the present invention, the system may be configured to retrieve information from one or more data sources regarding a user's account as well as the contents and status thereof.

According to embodiments of the present invention, the system may be configured to verify the user and commodity account, as well as the appropriateness of a particular transaction. The system may be further configured to utilize one or more sets of preferences to identify one or more particular commodities to utilize with respect to a particular transaction.

According to embodiments of the present invention, the system may be configured to select one or more commodities, value said commodities and commit a real-time or near real-time transaction (e.g., sale, purchase, option) with respect to said commodities.

According to embodiments of the present invention, the system may be configured to identify a currency to be utilized by a particular point of sale transaction initiated by a user. Once the currency is determined, the system may provide verification to the point of sale transaction in order to allow for the completion of the point of sale transaction.

In an alternate embodiment, where a point of sale merchant is appropriately linked to the system, the system may be further configured to commit a point of sale transaction directly in a quantity of a commodity as opposed to in a liquid currency.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic overview of a network system for carrying out this invention in accordance with an embodiment of the present invention;

FIG. 2 is an exemplary process flow for handling a real-time point of sale commodity exchange transaction, in accordance with an embodiment of the present invention;

FIG. 3 is an exemplary method for processing a sales request, in accordance with an embodiment of the present invention;

FIG. 4 is an exemplary method for obtaining a commodity mean spot price, in accordance with an embodiment of the present invention; and

FIG. 5 is an exemplary overview of a commodity exchange method, in accordance with an embodiment of the present invention.

### DETAILED SPECIFICATION

The present invention generally relates to commodity exchange systems. Specifically, this invention relates to a system and method for providing real-time commodity exchanges for point of sale transactions.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

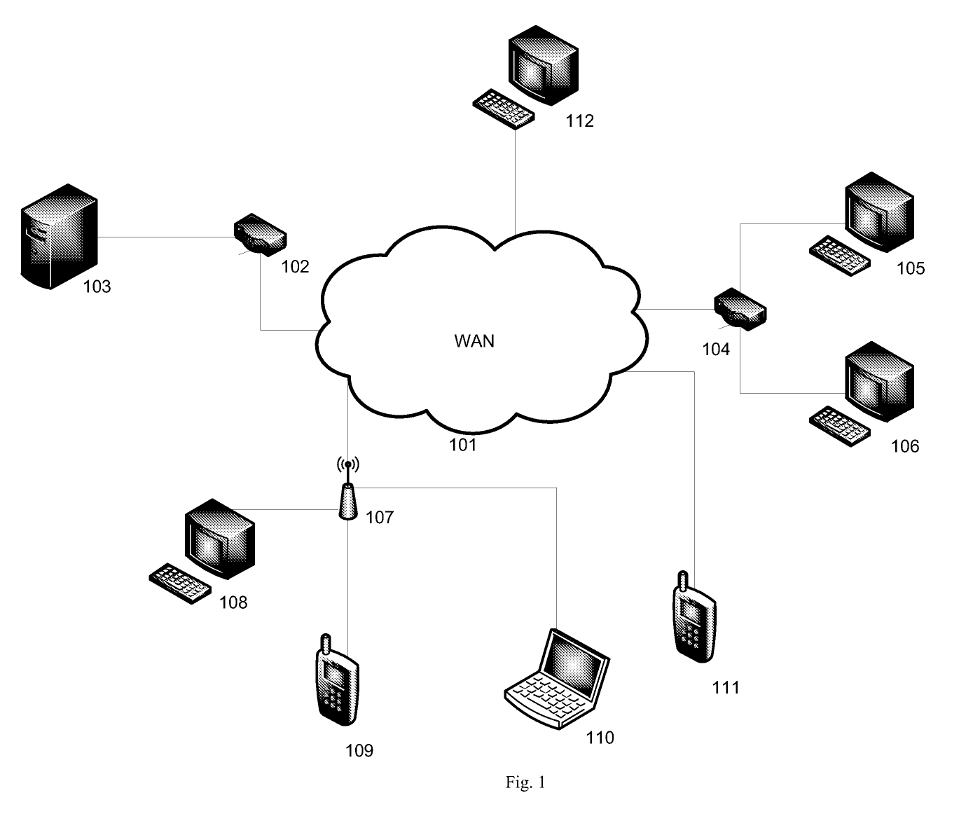

Referring to FIG. 1, a schematic overview of a system in accordance with an embodiment of the present invention is shown. The system is comprised of one or more application servers 103 for electronically storing information used by the system. Applications in the server 103 may retrieve and manipulate information in storage devices and exchange information through a WAN 101 (e.g., the Internet). Applications in server 103 may also be used to manipulate information stored remotely and process and analyze data stored remotely across a WAN 101 (e.g., the Internet).

According to an exemplary embodiment, as shown in FIG. 1, exchange of information through the WAN 101 or other network may occur through one or more high speed connections directed through one or more routers 102. Router(s) 102 are completely optional and other embodiments in accordance with the present invention may or may not utilize one or more routers 102. One of ordinary skill in the art would appreciate that there are numerous ways server 103 may connect to WAN 101 for the exchange of information, and embodiments of the present invention are contemplated for use with any method for connecting to networks for the purpose of exchanging information.

Components of the system may connect to server 103 via WAN 101 or other network in numerous ways. For instance, a component may connect to the system i) through a computing device 112 directly connected to the WAN 101, ii) through a computing device 105, 106 connected to the WAN 101 through a routing device 104, iii) through a computing device 108, 109, 110 connected to a wireless access point 107 or iv) through a computing device 111 via a wireless connection (e.g., CDMA, GMS, 3G, 4G) to the WAN 101. One of ordinary skill in the art would appreciate that there are numerous ways that a component may connect to server 103 via WAN 101 or other network, and embodiments of the present invention are contemplated for use with any method for connecting to server 103 via WAN 101 or other network.

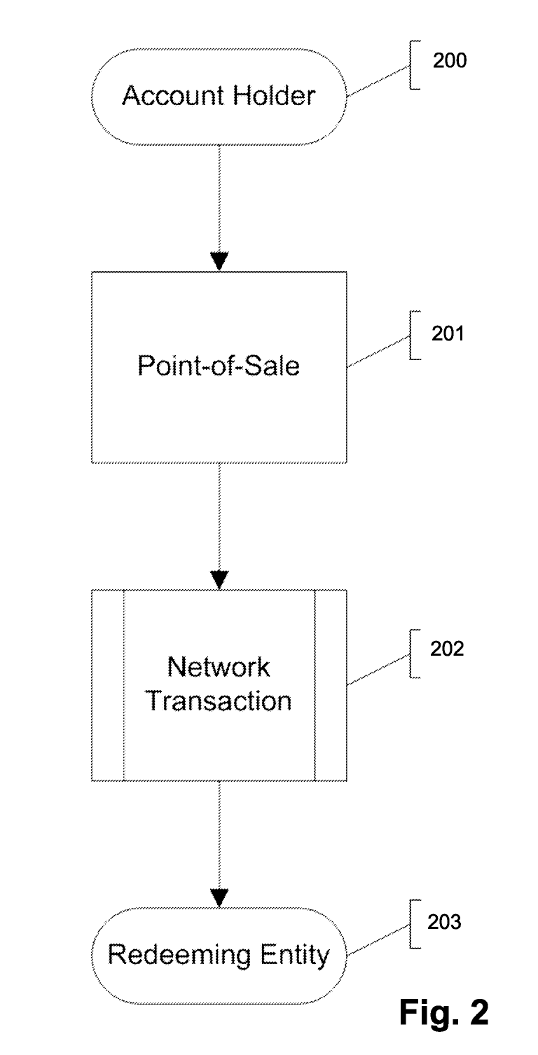

Turning now to FIG. 2, an exemplary method for handling a real-time point of sale commodity exchange transaction, in accordance with an embodiment of the present invention, is shown. At step 200, an account holder desires to initiate a point-of-sale transaction utilizing payment source linked to a commodity exchange account. In this preferred embodiment, the merchant may be completely unaware that the payment source is linked to a commodity exchange account as the payment source works with the merchant's existing payment source processing equipment (e.g., credit card reader).

According to an embodiment of the present invention, the payment source may be one or more of a type of payment source usable at a point of sale transaction terminal. For instance, payment sources may include, but are not limited to, debit cards, credit cards, RFID tags, near field communication (NFC) sources and checks. One of ordinary skill in the art would appreciate that there are numerous types of payment sources that may be utilized with embodiments of the present invention, and embodiments of the present invention are contemplated for use with any appropriate payment source.

At step 201, the merchant utilizes the payment source at their point-of-sale terminal. As with other point-of-sale terminal transactions, the merchant may require additional information from the purchaser to confirm their identity (e.g., requesting identification, signature) or ownership over the payment source (e.g., CVV code, CVV2 code, expiration date, photo confirmation).

At step 202, the point-of-sale terminal communicates with the remote transaction verification vendor as it would with any other payment verification transaction. Once communicated to the verification vendor, the verification vendor will contact the appropriate servers of the system in order to initiate and process the transaction. If successful, the servers of the system will send a confirmation to the verification vendor which allows the verification vendor to provide confirmation to the merchant's point-of-sale terminal.

At step 203, the point-of-sale terminal receives the confirmation and alerts the merchant that the transaction was completed successfully. As noted in this process, the merchant (i.e., redeeming entity) may be completely oblivious to the workings of the embodiments of the present invention, other than that they receive confirmation of a successful transaction as they would with any other payment source.

According to an embodiment of the present invention, this abstraction is desirable in that many consumers would not want a merchant to know anything about their finances or how they conduct their financial concerns. Since embodiments of the present invention appear to work like any other payment source, there is no need to alert a merchant to the variance in processing.

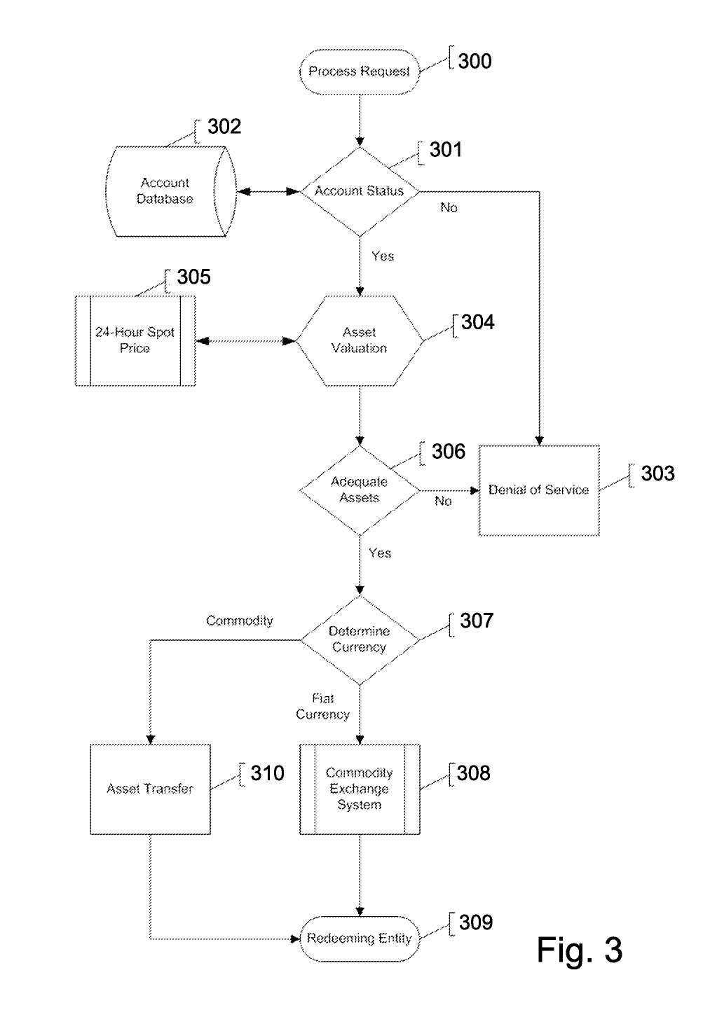

Continuing to FIG. 3, an exemplary method for processing a sales request, in accordance with an embodiment of the present invention, is shown. Here, the actual processing of a transaction request is detailed. This process begins at step 300 when a verification vendor or other third-party system contacts the present system for verification of a commodity exchange transaction. The system may be configured to provide an interface for allowing third-party systems to contact and provide data to the system. For instance, the system may utilize one or more Application Programming Interfaces (APIs) that allow third-party systems pertinent information in order to process a transaction. In preferred embodiments of the present invention, the system may require that the verification vendor be confirmed, registered or otherwise identifiable by the system prior to processing a transaction.

According to an embodiment of the present invention, the system may require certain information to be provided in order to process a transaction. For instance, the system may require the third-party system to provide an account number, value of the transaction, requested currency and location of the transaction. The system may also be configured to require or optionally accept information, including, but not limited to, a security code (e.g., CVV, CVV2), an expiration date, a name, an address, a pin code, an identification of a particular type of commodity to be utilized in the transaction, or any combination thereof. One of ordinary skill in the art would appreciate that there are numerous types of information that could be requested by the system and provided by the third-party system, and embodiments of the present invention are contemplated for use with any type of information.

At step 301, the system utilizes the information provided by the third-party system to begin the commodity exchange transaction process. At this point, the system is configured to verify the information provided as accurate and determine if the transaction is capable of completion. In a preferred embodiment, the system will first determine if the account identified by the third-party system is a valid account and whether the status of the account is limited or otherwise unable to process the transaction at this time (e.g., administratively frozen).

In a preferred embodiment of the present invention, the system will verify the aforementioned account information by way of checking information stored in one or more account databases (step 302). Account databases may be stored locally, remotely, on one or more servers or other computing devices or any combination thereof. One of ordinary skill in the art would appreciate that there are numerous databases and other data stored methods/systems that can be utilized with embodiments of the present invention, and embodiments of the present invention are contemplated for use with any type of database.

If the system determines the transaction is not capable of being completed as requested, the system will send a denial of service (DoS) message to the requesting third-party system (step 303). This DoS message may be a simple denial message, stating that the transaction was not able to be completed as requested. Alternatively, the DOS message may contain additional information, including, but not limited to, why the transaction was denied.

If the account is verified, the process continued to step 304, where the system determines a valuation of the assets associated with the account. The current valuation of the assets is determined at step 305. In a preferred embodiment of the present invention, the current valuation of an account is determined using a 24-hour mean spot price of the held assets. One of ordinary skill in the art would appreciate that valuations may be determined in numerous manners, and embodiments of the present invention are contemplated for use with any method of valuing an account and its assets.

At step 306, the system utilizes the account valuation from obtained in steps 304 and 305 to determine if there are adequate assets to process the requested transaction. If the system determines there are inadequate assets to complete the transaction, the system sends a DoS message as described in step 303 above.

If the system determines the account has adequate assets, the process continued to step 307, whereby the system determines (e.g., from the information provided by the third-party system, from information specified with the user and stored in the system or any combination thereof) what currency the transaction should be conducted in. Transactions may be conducted in fiat currencies (step 308), commodities (step 310) or any combination thereof. For instance, a commodity exchange transaction may be conducted where the merchant requests a specific amount in US Dollars (USD), a specific amount of platinum, or some combination thereof. Any currency and any commodity may be utilized with embodiments of the present invention.

According to an embodiment of the present invention, in transactions where commodities are being exchanged, a clearing period may be utilized (e.g., 24 hours) in order to protect and confirm the transaction. For transactions in fiat currencies, the system forwards an appropriate sales request to a commodity exchange system.

According to an embodiment of the present invention, the commodity exchange system is configured to process the sale of an appropriate amount of a commodity in order to complete the transaction in the specified currency. For instance, if the transaction is requesting $100 (USD), the system may be configured to sell $100 (USD) worth of platinum held in the account of the user in order to cover the transaction amount.

According to an embodiment of the present invention, the commodity exchange system may be configured to sell commodities based on one or more data points provided to it during or prior to the transaction request. For instance, the owner of the account may specify an order in which commodities should be sold (e.g., gold first, platinum second, copper third), the owner of an account may specify to sell commodities trading at extremes (e.g., at 52-week highs, at 52-week lows), the owner of an account may specify to sell commodities based on current performance (e.g., commodities declining in price, commodities increasing in price) or the transaction information may identify a particular commodity to be sold. One of ordinary skill in the art would appreciate that there are numerous ways to determine which commodity should be utilized in a transaction, and embodiments of the present invention are contemplated for use with any method for determining which commodity should be utilized.

At step 309, the process completes when the system returns to the third-party system, or other redeeming entity, a transaction confirmation. The transaction confirmation contains information pertinent to the resolution of the transaction (e.g., confirmation number, batch number, date, time, account name). One of ordinary skill in the art would appreciate that the transaction confirmation may be comprised of a variety of information, and embodiments of the present invention are contemplated for use with any type of information.

One of ordinary skill in the art would appreciate that the steps listed above may be executed in any order and various embodiments of the present invention may require fewer or additional steps.

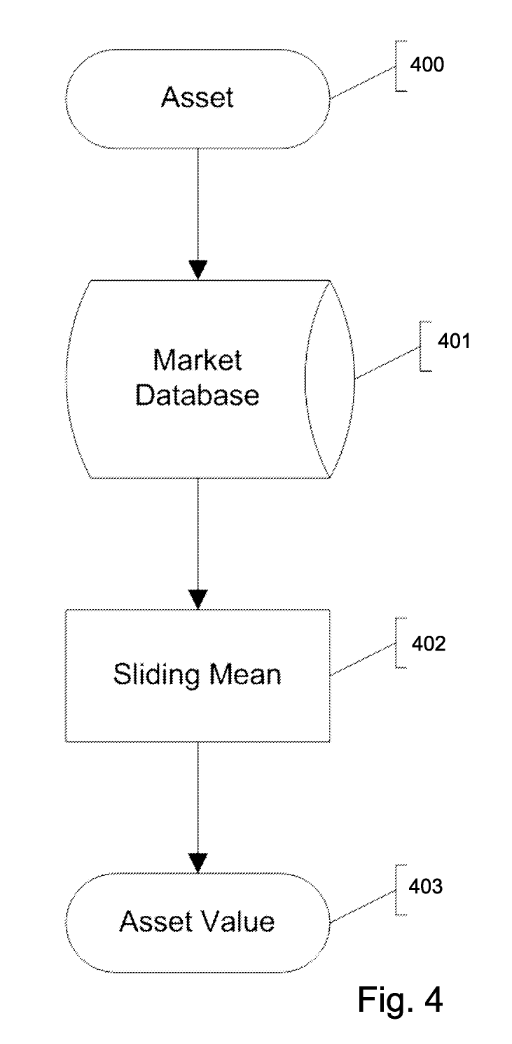

Turning now to FIG. 4, an exemplary method for obtaining a commodity mean spot price (such as that described in step 305 above), in accordance with an embodiment of the present invention is shown. In step 400, an asset is identified and selected by the system and provided to a commodity exchange system.

At step 401, the commodity exchange system matches the transaction location to an appropriate market database. According to exemplary embodiments of the present invention, the location of the transaction is important in order to identify the local currency for the valuation. In alternate embodiments, a location may be selected from one or more sources (e.g., a predetermined location associated with the account, a location identified by the user at the time of the transaction, a location identified by a verification vendor or other third-party). In other embodiments, no location may be required and a location agnostic market database may be utilized. The market database stores a sliding 24-hour mean value (shown in step 402), based on the local spot price for the identified asset involved. This local spot price is constantly maintained by the commodity exchange system.

At step 403, the mathematically derived asset valuation and asset quantity provided by the commodity exchange system is returned to the requesting system. One of ordinary skill in the art would appreciate that the steps listed above may be executed in any order and various embodiments of the present invention may require fewer or additional steps. Additionally, one of ordinary skill in the art would appreciate that there are numerous methods for determining a current value for an asset/commodity, and embodiments of the present invention are contemplated for use with any method of determining a value for an asset/commodity.

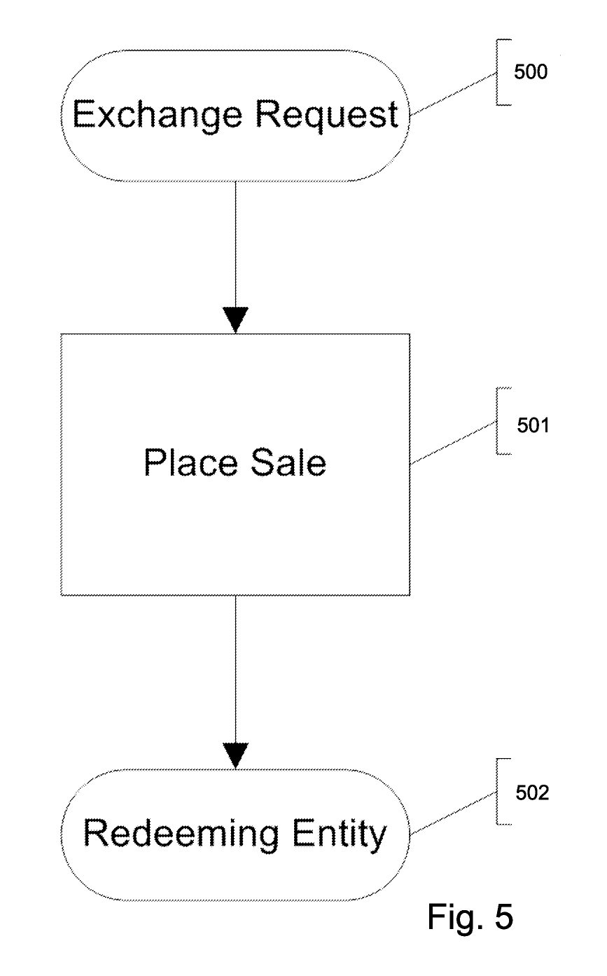

Turning now to FIG. 5, an exemplary overview of a commodity exchange method, in accordance with an embodiment of the present invention, is shown. At step 500, a commodity exchange system receives a request to process a specified quantity of an asset in a requested currency type. In a preferred embodiment, at step 501, the appropriate asset quantity will be sold in equal increments over the subsequent 24-hours at the sliding spot price. At step 502, the process completes with the sales proceeds being released to the seller. One of ordinary skill in the art would appreciate that the steps listed above may be executed in any order and various embodiments of the present invention may require fewer or additional steps.

In the previous examples, the use of 24-hour time periods have been utilized frequently. One of ordinary skill in the art would appreciate that any reference to 24-hour time periods, or other time periods, may be exchanged for real-time/instantaneous time periods as well as any time period that is longer or shorter than 24-hours. 24-hours is utilized to describe a preferred embodiment of the present invention, however there are numerous situations which may warrant the use of longer or shorter time periods, and embodiments of the present invention are contemplated for use with any time period.

While descriptions herein have focused primarily on point-of-sale transactions, embodiments of the present invention may be utilized in any transaction for the exchange of goods or services or other transaction type. One of ordinary skill in the art will appreciate that there are numerous types of transactions that embodiments of the present invention could be utilized to complete, and embodiments of the present invention are contemplated for use with any type of transaction.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method for providing a real-time commodity exchange, said method comprising:
receiving a request to process a real-time commodity exchange transaction, wherein said request comprises request information;
verifying an account status based at least in part on said request information;
identifying one or more assets based at least in part on said request information;
determining a valuation of said one or more assets;
determining one or more currency types to be utilized in completing said request;
determining amounts of said one or more asset to be utilized in completing said request;
committing one or more commodity transactions; and
transmitting confirmation of the completion of said request.

2. The method of claim 1, wherein said valuation is determined through use of a 24-hour spot price.

3. The method of claim 1, wherein at least one of said commodity transactions is an asset transfer.

4. The method of claim 1, wherein at least one of said commodity transactions is a fiat currency transaction.

5. The method of claim 4, wherein said fiat currency transaction is completed by selling one or more assets via a commodity exchange system.

6. The method of claim 1, wherein said request information comprises an account number.

7. The method of claim 1, wherein said request information comprises user identification information.

8. A computer-readable medium that stores computer-executable instructions that are executable by a computer processor, the instructions when executed embodying a method that comprises:
using a computer processor to store, in a tangible computer-readable medium, a plurality methods for providing a real-time commodity exchange;
receiving a request to process a real-time commodity exchange transaction, wherein said request comprises request information;
verifying an account status based at least in part on said request information;
identifying one or more assets based at least in part on said request information;
determining a valuation of said one or more assets;
determining one or more currency types to be utilized in completing said request;
determining amounts of said one or more asset to be utilized in completing said request;
committing one or more commodity transactions; and
transmitting confirmation of the completion of said request.

9. The computer-readable medium of claim 8, wherein said valuation is determined through use of a 24-hour spot price.

10. The computer-readable medium of claim 8, wherein at least one of said commodity transactions is an asset transfer.

11. The computer-readable medium of claim 8, wherein at least one of said commodity transactions is a fiat currency transaction.

12. The computer-readable medium of claim 11, wherein said fiat currency transaction is completed by selling one or more assets via a commodity exchange system.

13. The computer-readable medium of claim 8, wherein said request information comprises an account number.

14. The computer-readable medium of claim 8, wherein said request information comprises user identification information.
